(19) United States
(12) Patent Application Publication
(10) Pub. No.: US 2024/0391457 A1
(43) Pub. Date: Nov. 28, 2024

(54) VEHICLE CONTROL APPARATUS

(71) Applicant: Mitsubishi Electric Corporation, Tokyo (JP)

(72) Inventors: Kenta TOMINAGA, Tokyo (JP); Kazuhiro Nishiwaki, Tokyo (JP); Yuko Omagari, Tokyo (JP); Mizuho Wakabayashi, Tokyo (JP); Yuichi Okura, Tokyo (JP); Junya Hattori, Tokyo (JP)

(73) Assignee: Mitsubishi Electric Corporation, Tokyo (JP)

(21) Appl. No.: 18/612,378

(22) Filed: Mar. 21, 2024

(30) Foreign Application Priority Data
May 25, 2023 (JP) 2023-085884

(51) Int. Cl. B60W 30/095; B60W 40/10; B60W 50/00

(52) U.S. Cl. CPC B60W 30/095; B60W 40/10; B60W 50/0097; B60W 2520/06; B60W 2554/801

(57) ABSTRACT

To provide a vehicle control apparatus which sets a target trajectory considered an obstacle which exists in a changing lane, and can improve safety and comfort of occupant. A vehicle control apparatus sets an entry prohibition area based on at least one of a movement prediction of an obstacle, and/or road information; calculates a target trajectory under a constraint of not entering into the entry prohibition area; and when calculating a target trajectory for changing lanes from a changing origin lane to a changing destination lane, changes the entry prohibition area, based on a position of an ego vehicle with respect to the changing origin lane or the changing destination lane.

### INCORPORATION BY REFERENCE

The disclosure of Japanese Patent Application No. 2023-85884 filed on May 25, 2023 including its specification, claims and drawings, is incorporated herein by reference in its entirety.

### BACKGROUND

The present disclosure relates to a vehicle control apparatus.

Recently, various technologies for controlling the vehicle traveling has been proposed. As one of them, an apparatus which controls a lane change in which a vehicle moves from the present traveling lane to the adjacent lane has been developed.

For example, in the vehicle control apparatus of JP 2021-126990 A, entry prohibition areas are set around two obstacles in the changing destination lane, a target space is set between them, a target route is determined based on a movement prediction of the target space, and the lane change is performed.

### SUMMARY

If the entry prohibition area is set around the obstacle like JP 2021-126990 A, for example, when the front obstacle decelerates at a timing when the ego vehicle moved to the changing destination lane to a certain degree, the ego vehicle may unnaturally go around the side of the front obstacle, that is, the ego vehicle may return to the changing origin lane and avoid the collision, even if it is natural for the ego vehicle to decelerate and avoid a collision, and safety and comfort are reduced.

Then, the purpose of the present disclosure is to provide a vehicle control apparatus which sets a target trajectory considered an obstacle which exists in a changing destination lane, considering a progress degree of a lane change, and can improve safety and comfort of occupant.

A vehicle control apparatus according to the present disclosure, including:
an entry prohibition area setting unit that sets an entry prohibition area of an ego vehicle, based on at least one of a movement prediction of an obstacle, and/or road information;
a target trajectory generation unit that calculates a target trajectory in future of the ego vehicle under a constraint of not entering into the entry prohibition area; and
a vehicle control unit that controls a traveling of the ego vehicle based on the target trajectory,
wherein, when the target trajectory generation unit calculates the target trajectory for changing lanes from a changing origin lane to a changing destination lane, the entry prohibition area setting unit changes the entry prohibition area, based on a position in a lateral direction of the ego vehicle with respect to the changing origin lane or the changing destination lane.

In the present disclosure, “at least one of A and/or B” means A alone, B alone, or A and B together.

According to the vehicle control apparatus of the present disclosure, the entry prohibition area is changed based on the position in the lateral direction of the ego vehicle with respect to the changing origin lane or the changing destination lane when calculating the target trajectory for changing lanes. So, according to the progress degree of the lane change, the entry prohibition area which is set based on the movement prediction of the obstacle existing in the changing destination lane can be changed. Accordingly, for example, in a state where the lane change is progressing considerably, the target trajectory to return to the changing origin lane in order to avoid the obstacle in the changing destination lane can be prevented from being calculated. In a state where the lane change is not progressing almost, the target trajectory to return to the changing origin lane in order to avoid the obstacle in the changing destination lane can be calculated. Therefore, unnatural lane change can be suppressed, and safety and comfort of the occupants can be improved.

### BRIEF DESCRIPTION OF THE DRAWINGS

FIG. 1 is a block diagram showing an example of the vehicle control apparatus, according to Embodiment 1;

FIG. 2 is a figure showing an example of the ego vehicle, according to Embodiment 1;

FIG. 3 is a figure showing an example of the coordinate system, according to Embodiment 1;

FIG. 4 is a figure showing an example of the route coordinate system, according to Embodiment 1;

FIG. 5 is a flowchart showing an example of the procedure of automated driving of the ego vehicle, according to Embodiment 1;

FIG. 6 is a flowchart showing an example of the setting procedure of the entry prohibition area, according to Embodiment 1;

FIG. 7 is a schematic diagram showing an example of the surrounding entry prohibition area, according to Embodiment 1;

FIG. 8 is a schematic diagram showing an example of the inter-vehicle entry prohibition area, according to Embodiment 1;

FIG. 9 is an another schematic diagram showing an example of the inter-vehicle entry prohibition area, according to Embodiment 1;

FIG. 10 is a flowchart showing the generation procedure of the target trajectory, according to Embodiment 1;

FIG. 11A to FIG. 11C are schematic diagrams showing examples of the entry prohibition area during the lane change, according to Embodiment 1;

FIG. 12 is a flowchart showing an example of the setting procedure of the entry prohibition area, according to Embodiment 2;

FIG. 13 is a schematic diagram showing an example of the surrounding entry prohibition area, according to Embodiment 2;

FIG. 14 is a schematic diagram showing an example of superposition of the lane entry prohibition area and the surrounding entry prohibition area, according to Embodiment 2;

FIG. 15 is an another schematic diagram showing an example of superposition of the lane entry prohibition area and the surrounding entry prohibition area, according to Embodiment 2;

FIG. 16 is a flowchart showing an example of the setting procedure of the entry prohibition area, according to Embodiment 3; and

FIG. 17 is a schematic hardware configuration figure of the vehicle control unit and the vehicle control apparatus, according to Embodiment 1.

### DETAILED DESCRIPTION OF THE EMBODIMENTS

### Embodiment 1

### <Block Diagram>

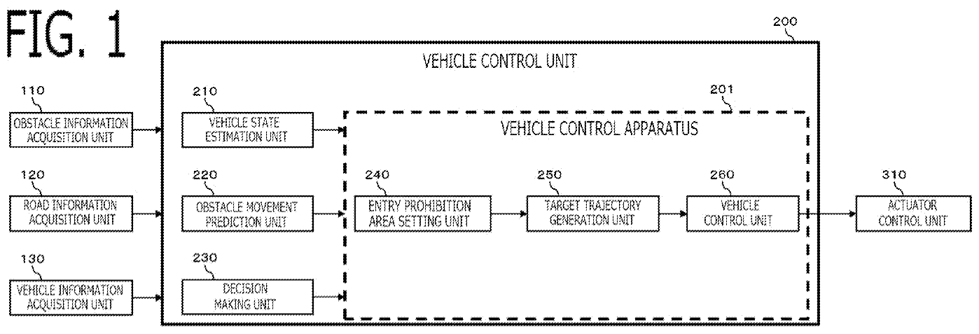

FIG. 1 is a block diagram showing an example of a vehicle control apparatus 201 according to Embodiment 1 of the present disclosure. The vehicle control apparatus 201 according to Embodiment 1 is included in a vehicle control unit 200 of a vehicle. In the following explanation, the vehicle in which the vehicle control apparatus 201 is provided may be described as “ego vehicle”.

The vehicle control apparatus 201 of FIG. 1 is provided with an entry prohibition area setting unit 240, a target trajectory generation unit 250, and a vehicle control unit 260. The vehicle control unit is a unit which controls the vehicle, for example, is mounted in the advanced driver-assistance system electronic control unit (ADAS-ECU).

The entry prohibition area setting unit 240 sets an entry prohibition area of the ego vehicle, based on at least one of a movement prediction of an obstacle, and/or road information. When the obstacle exists around the ego vehicle and obstacle movement prediction information which is movement prediction information of the obstacle including the position of the obstacle is acquired from the obstacle movement prediction unit 220, the entry prohibition area setting unit 240 sets the entry prohibition area around the predicted obstacle. The entry prohibition area setting unit 240 sets the entry prohibition area of the ego vehicle, based on the road information. As an example, the entry prohibition area is set to the outside of the lane marking based on the lane marking. When one of the movement prediction of the obstacle and the road information is not acquired, the entry prohibition area setting unit 240 sets the entry prohibition area of the ego vehicle, based on acquired one of the movement prediction of the obstacle and the road information.

The target trajectory generation unit 250 generates a target trajectory to be traveled by the ego vehicle, based on the road information which is information from the road information acquisition unit 120 including boundary parts of the road where the ego vehicle travels and each road adjacent to it, the decision making information which is information from the decision making unit 230 including the target behavior to be taken by the ego vehicle and the target lane to be traveled by the ego vehicle, and the entry prohibition area from the entry prohibition area setting unit 240.

The vehicle control unit 260 calculates target values for performing a steering control and a speed control so that the ego vehicle follows the target trajectory. The target values are a target steering angle, a target acceleration, and the like.

The vehicle control unit 200 is connected with the obstacle information acquisition unit 110, the road information acquisition unit 120, and the vehicle information acquisition unit 130 as external input devices.

The obstacle information acquisition unit 110 is an acquisition unit which acquires the obstacle information which is information including the position of the obstacle. For example, it may be a front camera, and may be LiDAR (Light Detection and Ranging), a radar, a sonar, a vehicle-to-vehicle communication device, a road-to-vehicle communication device, and the like.

The road information acquisition unit 120 is an acquisition unit which acquires the road information which is information including the boundary part of the road where the ego vehicle travels. For example, it may be the front camera, may be a combination of LiDAR and a map data processor, and may be a combination of Global Navigation Satellite System (GNSS) and the map data processor. The boundary part may be a lane marking, and may be a curb, a gutter, and a guardrail, for example.

The vehicle information acquisition unit 130 is an acquisition unit which acquires the vehicle information of the ego vehicle. The vehicle information acquisition unit 130 may be a steering angle sensor, a steering torque sensor, a yaw rate sensor, a speed sensor, and an acceleration sensor, for example. The vehicle information is a present vehicle state of the ego vehicle, and is acquired using at least one of these sensors, for example.

The vehicle control unit 200 is provided with a vehicle state estimation unit 210 connected with the vehicle control apparatus 201, the obstacle movement prediction unit 220, and the decision making unit 230 as internal components.

The vehicle state estimation unit 210 estimates the present vehicle state of the ego vehicle which is not acquired by the vehicle information acquisition unit 130, based on the vehicle information. The vehicle state estimation unit 210 may estimate a part of the vehicle information acquired by the vehicle information acquisition unit 130.

The obstacle movement prediction unit 220 performs a movement prediction of the obstacle, based on the obstacle information which is information from the obstacle information acquisition unit 110 including the position of the obstacle, and the road information which is information from the road information acquisition unit 120 including boundary parts of the road where the ego vehicle travels and the each road adjacent to it.

The decision making unit 230 determine the target behavior to be taken by the ego vehicle and the target lane to be traveled by the ego vehicle, based on the obstacle information, the road information, and the vehicle information. The target behavior is a lane keeping and a lane change, for example. The target lane is an ego lane, a left lane, and a right lane, for example.

The vehicle control unit 200 is connected with an actuator control unit 310 as an external output device. The actuator control unit 310 is a control unit which controls actuators based on the target values from the vehicle control apparatus 201. For example, it may be EPS-ECU (Electric Power Steering-Electric Control Unit), and may be a powertrain ECU, a brake ECU, and an electric vehicle ECU. In the present embodiment, the vehicle control unit performs a steering control and a speed control, and the actuator control unit 310 consists of EPS-ECU, the powertrain ECU, and the brake ECU. But, it is not limited to this.

### <System Configuration Diagram>

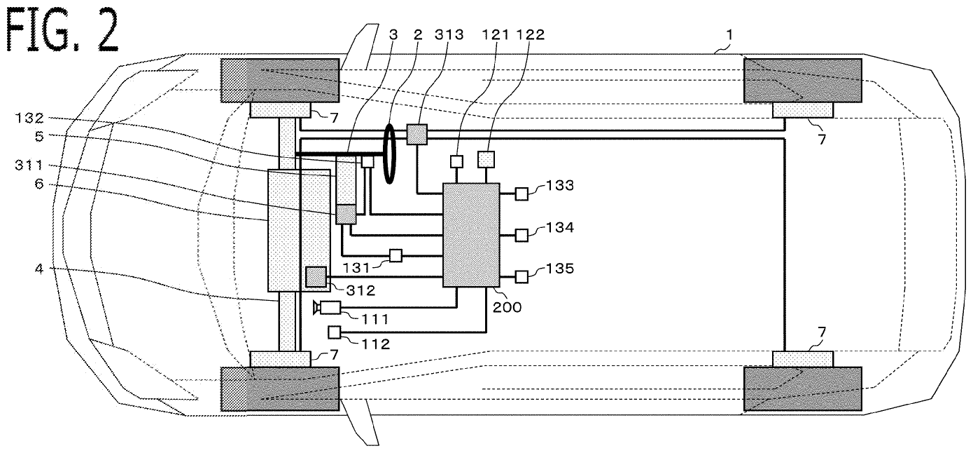

FIG. 2 is a system configuration diagram showing a schematic configuration of the vehicle control apparatus of Embodiment 1. The ego vehicle 1 is provided with a steering wheel 2, a steering axis 3, a steering unit 4, an EPS motor 5, a powertrain unit 6, a brake unit 7, a front camera 111, a radar sensor 112, GNSS 121, a navigation apparatus 122, a steering angle sensor 131, a steering torque sensor 132, a yaw rate sensor 133, a speed sensor 134, an acceleration sensor 135, a vehicle control unit 200, an EPS controller 311, a power train controller 312, and a brake controller 313. The EPS controller 311, the power train controller 312, and the brake controller 313 correspond to the actuator control unit 310 mentioned above.

The steering wheel 2 which is installed for the driver to operate the ego vehicle 1 is coupled with the steering axis 3. The steering unit 4 is connected with the steering axis 3. The steering unit 4 supports the front wheels as steered wheels, and is rotatably supported by a vehicle body frame. Therefore, a torque generated by operation of the steering wheel 2 of the driver rotates the steering axis 3, and steers the front wheels in the right or left direction by the steering unit 4. Thereby, the driver can operate a lateral movement amount of the vehicle when the vehicle moves forward or backward. The steering axis 3 can also be rotated by the EPS motor 5, and by controlling current flowing into the EPS motor 5 by the EPS controller 311, the front wheels can be steered independently from the operation of the steering wheel 2 of the driver.

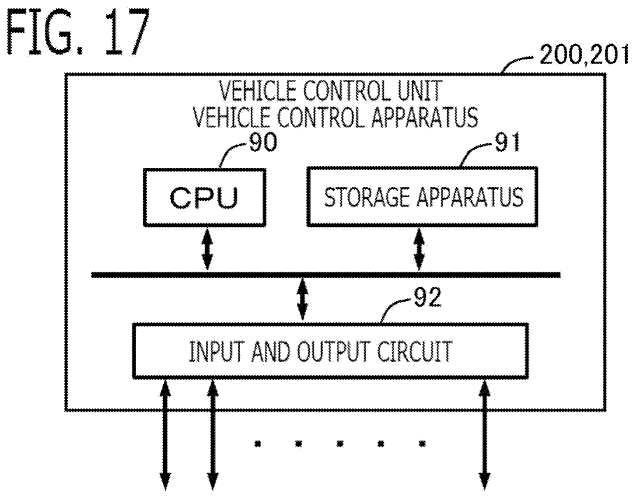

For example, as shown in FIG. 17, the vehicle control unit 200 is provided with an arithmetic processor 90 such as CPU (Central Processing Unit), storage apparatuses 91, an input and output circuit 92 which outputs and inputs external signals to the arithmetic processor 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatuses, such as RAM (Random Access Memory), ROM (Read Only Memory), a flash memory, EEPROM (Electrically Erasable Programmable Read Only Memory), a hard disk, and a DVD (Digital Versatile Disc) apparatus, are used.

The input and output circuit 92 is provided with a communication device, an A/D converter, an input/output port, a driving circuit, and the like. The input and output circuit 92 is connected with the front camera 111, the radar sensor 112, GNSS 121, the navigation apparatus 122, the steering angle sensor 131 for detecting a steering angle, the steering torque sensor 132 for detecting a steering torque, the yaw rate sensor 133 for detecting a yaw rate, the speed sensor 134 for detecting a speed of the ego vehicle, the acceleration sensor 135 for detecting an acceleration of the ego vehicle, the EPS controller 311, the power train controller 312, and the brake controller 313.

The vehicle control unit 200 processes information inputted from the connected sensors, according to the program stored in ROM, transmits the target steering angle to the EPS controller 311, and transmits the target acceleration to the power train controller 312 and the brake controller 313.

The front camera 111 is installed at a position where the lane marking in front of the vehicle can be detected as an image, and detects a front environment of the ego vehicle, such as lane information and a position of the obstacle, based on image information. In the present embodiment, only the camera which detects the front environment was mentioned as the example, but a camera which detects rear or side environment may also be installed.

The radar sensor 112 irradiates radar and detect its reflected wave to output a relative distance and a relative speed between the ego vehicle 1 and the obstacle. As this radar sensor, well-known sensors, such as a millimeter wave radar, LiDAR, a laser range finder, and an ultrasonic radar, can be used.

The GNSS sensor 121 receives radio waves from positioning satellites with an antenna and calculates positioning to output an absolute position and an absolute azimuth of the ego vehicle.

The navigation apparatus 122 has a function to calculate the optimal traveling route to a destination set by the driver, and records the road information on the traveling route. The road information is map node data expressing a road alignment, and each map node data have information on an absolute position (latitude, longitude, and altitude), a lane width, a cant angle, a slope angle at each node.

The EPS controller 311 controls the EPS motor 5 based on the target steering angle transmitted from the vehicle control unit 200.

The power train controller 312 controls the powertrain unit 6 to realize the target acceleration transmitted from the vehicle control unit 200. In the present embodiment, the vehicle which has only the engine as the driving force source was mentioned as the example, but the vehicle which has only an electric motor as the driving force source, or the vehicle which has both the engine and the electric motor as the driving force source may be used.

The brake controller 313 controls the brake unit 7 to realize the target acceleration transmitted from the vehicle control unit 200.

### <Coordinate System>

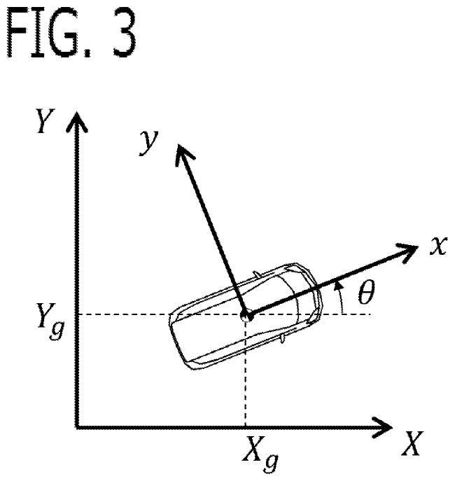

FIG. 3 is a figure which expressed schematically a coordinate system used in Embodiment 1. In FIG. 3, X and Y express an inertial coordinate system, and Xg, Yg, and θ express a centroid position and a body yaw angle of the ego vehicle in the inertial coordinate system. x and y are an ego vehicle coordinate system which sets the origin to a center of gravity of the ego vehicle, sets x-axis to the front direction of the ego vehicle, and set y-axis to the left direction.

In the present embodiment, the centroid position Xg, Yg and the body yaw angle θ of the vehicle are initialized to 0 every execution cycle. That is, the inertial coordinate system and the ego vehicle coordinate system are coincided every execution cycle.

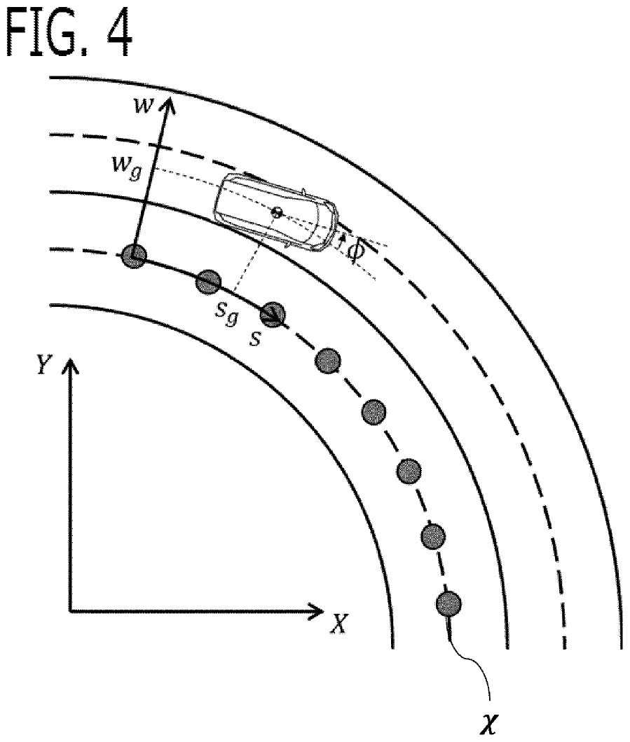

And, in the present embodiment, in a certain route x, a route coordinate system expressed by a tangential direction s and a normal direction w of the route χ is also used. FIG. 4 is a figure expressing schematically the route coordinate system used in Embodiment 1. The point sequence of FIG. 4 is a point sequence showing the route x, and is the center of the lane in this case. But the route is not limited to the center of the lane, as long as it is the point sequence of the position. In FIG. 4, s and w are the route coordinate system, and sg, wg, and φ are the centroid position and the body yaw angle of the ego vehicle in the route coordinate system.

### <Setting of an Optimization Problem>

In the present embodiment, the target trajectory generation unit 250 predicts a vehicle state x from the present time 0 to prediction period Th future at a prediction interval Ts, using a vehicle model f mathematically expressing motion of the vehicle; and solves an optimization problem for calculating series data of a control input u which minimizes an evaluation function J expressing desirable operation of the ego vehicle under a constraint g. Then, based on the optimized control input u calculated from the optimization problem, and the vehicle model f, the target trajectory generation unit 250 predicts series data of the optimized vehicle state x from the present time 0 to the prediction period Th future at the prediction interval Ts. Then, based on the series data of the control input u and the series data of the vehicle state x which were optimized, the target trajectory generation unit 250 generates a trajectory ξ which is series data including the position of the ego vehicle. In the following explanation, a period from the present time to the prediction period Th may be abbreviated as a horizon.

### <Formulation of Optimization Problem>

As mentioned above, in the present embodiment, a constrained optimization problem is solved for every prescribed period. The optimization problem is formulated as follows.

$$\begin{matrix}[ Math . 1 ] & \\ {min}_{u} J & ( 101 )\end{matrix}$$

$$\begin{matrix}s . t . & \dot{x} = f ( x , u ) \\ & {x}_{0} = x ( 0 ) \\ & g ( x , u ) \leq 0\end{matrix} \qquad ( 102 )$$

Herein, J is the evaluation function, x is the vehicle state, u is the control input, f is a vector valued function regarding a dynamic vehicle model, and x0 is an initial value, that is, the present vehicle state. g is a vector valued function regarding the constraint, and the optimization is executed under the constraint g (x, u)<=0. In the present embodiment, the above optimization problem is dealt with as a minimization problem, but it can be dealt with as a maximum problem by inverting the sign of the evaluation function.

In the present embodiment, the next equation is used for the evaluation function J.

$$\begin{matrix}[ Math . 2 ] & \\ J = {( {h}_{N} ( x ( N ) ) - r ( N ) )}^{T} {W}_{N} ( {h}_{N} ( x ( N ) ) - r ( N ) ) + {\sum }_{k = 0}^{N - 1} {( h ( x ( k ) , u ( k ) ) - r ( k ) )}^{T} W ( h ( x ( k ) , u ( k ) ) - r ( k ) ) & ( 103 )\end{matrix}$$

Herein, x (k) is the vehicle state at the prediction point k (k=0, . . . , N), and u (k) is the control input at the prediction point k (k=0, . . . , N−1). h is a vector valued function regarding the evaluation item, hN is a vector valued function regarding the evaluation item at the end (prediction point N), and r (k) is a reference value at the prediction point k (k=0, . . . , N). W and WN are weight matrices which are diagonal matrices with weights for each evaluation item in the diagonal components, and can be changed arbitrarily as parameters.

### <Vehicle Model>

In the present embodiment, the vehicle state x and the control input u which are used by the control amount calculation unit are set as follows.

$$\begin{matrix}[ Math . 3 ] & \\ x = {[ {X}_{g} , {Y}_{g} , θ , β , γ , V , {a}_{x} , {a}_{xt} , δ , {δ}_{t} ]}^{T} & ( 104 )\end{matrix}$$

$$u = {[ {j}_{xt} , {ω}_{t} ]}^{T} \qquad ( 105 )$$

Herein, β is a lateral slip angle, γ is a yaw rate, ax is a longitudinal acceleration, δ is a steering angle, axt is a target longitudinal acceleration, and δt is a target steering angle. jt is a target longitudinal jerk and ωt is a target steering angle speed. As long as a variable regarding the position is included in the vehicle state x, the vehicle state x and the control input u may be set in any way. The variable of the position is not limited to the orthogonal coordinate system, but may be defined in the route coordinate system, for example.

As the vehicle model f, a two-wheel model shown in the next equation is used.

$$\begin{matrix}[ Math . 4 ] & \\ \dot{x} = f ( x ) = [ \begin{matrix}V cos ( θ + β ) \\ V sin ( θ + β ) \\ γ \\ - γ + \frac{2}{MV} ( {F}_{f} + {F}_{r} ) \\ \frac{2}{I} ( {l}_{f} {F}_{f} - {l}_{r} {F}_{r} ) \\ {a}_{x} \\ \frac{{a}_{xt} - {a}_{x}}{{T}_{{a}_{x}}} \\ {j}_{xt} \\ \frac{{δ}_{o} - δ}{{T}_{δ}} \\ {ω}_{t}\end{matrix} ] & ( 106 )\end{matrix}$$

Herein, M is a vehicle mass, and I is a yaw inertia moment of the vehicle. If and Ir are distances from the axles of the front and rear wheels to the vehicle center of gravity. Tax and Tδ are time constants if the following properties to the target values of longitudinal acceleration and steering angle are expressed by a first order lag. Yf and Yr are cornering forces of the front and rear wheels, and are expressed by the next two equations using the cornering stiffnesses Cf, Cr of the front and rear wheels.

$$\begin{matrix}[ Math . 5 ] & \\ {Y}_{f} = - {C}_{f} ( β + \frac{{l}_{f}}{V} γ - δ ) & ( 107 )\end{matrix}$$

$${Y}_{r} = - {C}_{r} ( β - \frac{{l}_{r}}{V} γ ) \qquad ( 108 )$$

As the vehicle model f, a vehicle model other than the two-wheel model may be used.

### <Procedure of Vehicle Control Apparatus>

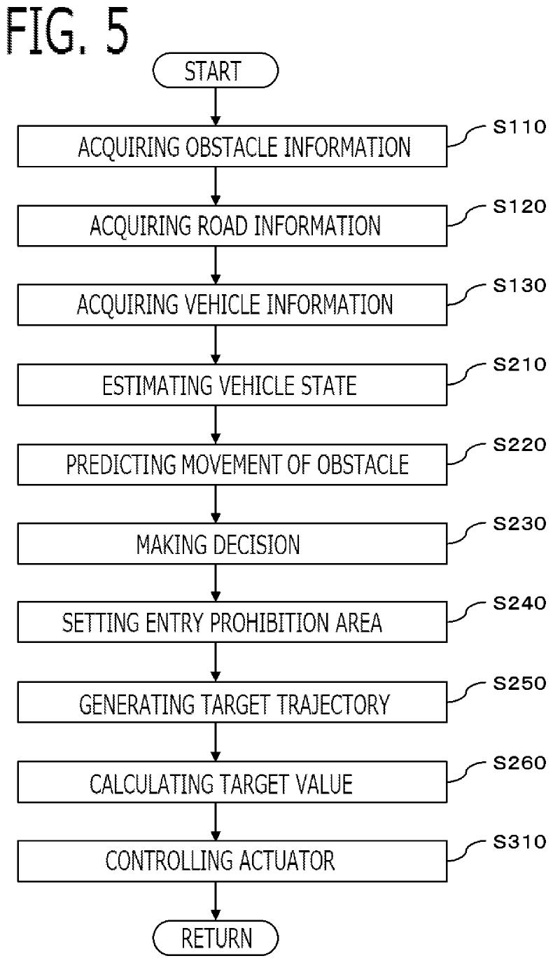

FIG. 5 is a flowchart showing an example of the procedure of automated driving of the ego vehicle according to Embodiment 1.

In S110 of FIG. 5, the obstacle information acquisition unit 110 acquires the obstacle information. The obstacle information is information including the position of the obstacle. In the present embodiment, when the obstacle exists in the left front to the ego vehicle, the positions of the right front end PFR, the right rear end PRR, and the left rear end PRL of the obstacle in the ego vehicle coordinate system are acquired. When the obstacle exists in the right front to the ego vehicle, the positions of the left front end PFL, the left rear end PRL, and right rear end PRR of the obstacle in the ego vehicle coordinate system are acquired. Further, based on those position information, the obstacle information acquisition unit estimates the position of the left front end PFL or the right front end PFR, a position Xo, Yo of center PC, a body yaw angle θo, a speed Vo, a length lo, and a width wo of the obstacle.

Next, in S120 of FIG. 5, the road information acquisition unit 120 acquires the road information. The road information is information including the boundary part of the road where the ego vehicle travels, and each road adjacent to it (hereinafter described as an ego lane, a left lane, and a right lane). In the present embodiment, coefficients if the right and left lane markings of the ego lane, the left lane, and the right lane are expressed by a third-order polynomial are acquired. That is, for the left lane marking of the ego lane (it is also the right lane marking of the left lane), values of cel0 to cel3 of the next equation are acquired.

$$\begin{matrix}[ Math . 6 ] & \\ Y = {c}_{el 3} {X}^{3} + {c}_{el 2} {X}^{2} + {c}_{el 1} X + {c}_{el 0} & ( 201 )\end{matrix}$$

For the right lane marking of the ego lane (it is also the left lane marking of the right lane), values of cer0 to cer3 of the next equation are acquired.

$$\begin{matrix}[ Math . 7 ] & \\ Y = {c}_{er 3} {X}^{3} + {c}_{er 2} {X}^{2} + {c}_{er 1} X + {c}_{er 0} & ( 202 )\end{matrix}$$

For the left lane marking of the left lane, values of cl10 to cl13 of the next equation are acquired.

$$\begin{matrix}[ Math . 8 ] & \\ Y = {c}_{ll 3} {X}^{3} + {c}_{ll 2} {X}^{2} + {c}_{ll 1} X + {c}_{ll 0} & ( 203 )\end{matrix}$$

For the right lane marking of the right lane, values of crr0 to crr3 of the next equation are acquired.

$$\begin{matrix}[ Math . 9 ] & \\ Y = {c}_{rr 3} {X}^{3} + {c}_{rr 2} {X}^{2} + {c}_{rr 1} X + {c}_{rr 0} & ( 204 )\end{matrix}$$

At this time, the center of the ego lane, the center of the left lane, and the center of the right lane are expressed by the equation (205), the equation (206), and the equation (207), respectively.

$$\begin{matrix}[ Math . 10 ] & \\ Y = {l}_{e} ( X ) = {c}_{ec 3} {X}^{3} + {c}_{ec 2} {X}^{2} + {c}_{ec 1} X + {c}_{ec 0} & ( 205 )\end{matrix}$$

$$Y = {l}_{l} ( X ) = {c}_{lc 3} {X}^{3} + {c}_{lc 2} {X}^{2} + {c}_{lc 1} X + {c}_{lc 0} \qquad ( 206 )$$

$$Y = {l}_{r} ( X ) = {c}_{rc 3} {X}^{3} + {c}_{rc 2} {X}^{2} + {c}_{rc 1} X + {c}_{rc 0} \qquad ( 207 )$$

Herein, each coefficient is expressed by the equation (208), the equation (209), and the equation (210).

$$[ Math . 11 ]$$

$${c}_{e c i} = \frac{( {c}_{e l i} + {c}_{e r i} )}{2} ( i = 0 , … , 3 ) \qquad ( 208 )$$

$${c}_{l c i} = \frac{( {c}_{e l i} + {c}_{lli} )}{2} ( i = 0 , … , 3 ) \qquad ( 209 )$$

$${c}_{r c i} = \frac{( {c}_{e r i} + {c}_{rri} )}{2} ( i = 0 , … , 3 ) \qquad ( 210 )$$

The information on lane marking is not limited to the third-order polynomial, but it may be expressed by any function. In the present embodiment, the road where the ego vehicle travels is defined as the road where the center of gravity of the ego vehicle exists. But the definition of the road where the ego vehicle travels is not limited to this definition.

In S130 of FIG. 5, the vehicle information acquisition unit 130 acquires the vehicle information. The vehicle information is information, including the steering angle, the yaw rate, speed, the acceleration, and the like of the ego vehicle. In the present embodiment, the steering angle δ, the yaw rate γ, the speed V, and the longitudinal acceleration ax are acquired.

Next, in S210 of FIG. 5, the vehicle state estimation unit 210 estimates the vehicle state x. Well-known technology, such as a low pass filter, an observer, a Kalman filter, and a particle filter, is used for estimation of the vehicle state.

Next, in S220 of FIG. 5, the obstacle movement prediction unit 220 performs the movement prediction of the obstacle. In the movement prediction, the center position Xo (k), Yo (k), the body yaw angle θo (k), and the speed Vo (k) of the obstacle at each prediction point k (k=0, . . . , N) are predicted. In the present embodiment, the obstacle is predicted to move along the lane at a constant speed. When a plurality of obstacles exist, the above prediction is performed for each obstacle. Any prediction other than this may be performed, for example, the prediction may be performed using a driver model.

Next, in S230 of FIG. 5, the decision making unit 230 performs the decision making. In the decision making, the target behavior to be taken by the ego vehicle and the target lane to be traveled by the ego vehicle is determined based on the obstacle information, the road information, and the vehicle information. In the present embodiment, options of the target behavior include a lane keeping and a lane change. A stop, an emergency stop, and the like may be included in addition to these.

Well-known technology, such as a finite state machine, an ontology, a decision tree, a reinforcement learning, and a Markov decision process, is used for the decision making. In the present embodiment, the finite state machine is used for the decision making. The target behavior is the lane keeping at the start of the automated driving. Then, the necessity of the lane change is determined based on the destination and the present traveling lane of the ego vehicle, and the target behavior is changed to the lane change. Besides, the necessity of overtaking of the ego vehicle is determined based on the movement prediction information, and the target behavior may be changed to the lane change when the overtaking is necessary. When the target behavior is the lane change, the lane change to the right, or the lane change to the left is also determined. This decision is made based on the position of an overtaking lane, and the like, for example.

For example, when the target behavior is the lane keeping, the ego lane is set as the target lane. When the target behavior is the lane change to the right, the right lane is set as the target lane. But, during the lane change, at the moment when the ego vehicle crosses the lane marking and moves to the right lane, the target lane becomes the right lane viewed from the original lane, that is, the ego lane after crossing. The same is applicable to the lane change to the left.

Next, in S240 of FIG. 5, the entry prohibition area setting unit 240 sets the entry prohibition area S. In the present embodiment, when the target trajectory generation unit 250 calculates the target trajectory for changing lanes from a changing origin lane to a changing destination lane, the entry prohibition area setting unit 240 changes the entry prohibition area, based on the position in the lateral direction of the ego vehicle with respect to the changing origin lane or the changing destination lane.

According to this configuration, According to the progress degree of the lane change, the entry prohibition area which is set based on the movement prediction of the obstacle existing in the changing destination lane can be changed. Accordingly, for example, in a state where the lane change is progressing considerably, the target trajectory to return to the changing origin lane in order to avoid the obstacle in the changing destination lane can be prevented from being calculated. In a state where the lane change is not progressing almost, the target trajectory to return to the changing origin lane in order to avoid the obstacle in the changing destination lane can be calculated. Accordingly, unnatural lane change can be suppressed, and safety and comfort of the occupants can be improved.

For example, before the ego vehicle moves to the changing destination lane to a certain degree, the entry prohibition area (hereinafter, referred to as a surrounding entry prohibition area) which surrounds the obstacle is set so that the ego vehicle can travel the side of the obstacle and does not approach the obstacle greater than or equal to a set distance. After the ego vehicle moves to the changing destination lane to a certain degree, the entry prohibition area (hereinafter, referred to as an inter-vehicle entry prohibition area) is set so that an inter-vehicle distance between the ego vehicle and the obstacle which exist in the changing destination lane is secured greater than or equal to the set distance. Accordingly, when the ego vehicle moves to the changing destination lane to a certain degree, the ego vehicle avoids the obstacle in the changing destination lane without returning to the changing origin lane. So, even when the obstacle in the changing destination lane accelerates or decelerates, the ego vehicle does not return to the changing origin lane unnaturally, and safety and comfort are improved. The reason for setting the entry prohibition area so that the ego vehicle can travel the side of the obstacle before the ego vehicle moves to the changing destination lane is to also deal with a case where the obstacle locates almost just beside the ego vehicle at the start of the lane change, and a case where the ego vehicle changes lanes while overtaking the obstacle or being overtaken by the obstacle.

Next, in S250 of FIG. 5, the target trajectory generation unit 250 generates the target trajectory ξ by solving the optimization problem of the equation (101). The target trajectory ξ is series data including the target position of the ego vehicle. In the present embodiment, it is series data of the vehicle state x of the equation (104).

Next, in S260 of FIG. 5, the vehicle control unit 260 calculates the target value for performing the steering control and the speed control so that the ego vehicle follows the target trajectory ξ. In the present embodiment, the target steering angle δt which is a target value regarding steering, and the target longitudinal acceleration axt which is a target value regarding the vehicle speed are calculated. In the present embodiment, since the target trajectory ξ includes the optimal value of the target steering angle δt (k) and the optimal value of the target longitudinal acceleration axt (k) at each prediction point k (k=0, . . . , N), the target steering angle δt and the target longitudinal acceleration axt are calculated respectively by interpolating the optimal value of target steering angle δt (k) and the optimal value of the target longitudinal acceleration axt (k) in the time direction according to a control cycle of each actuator.

Next, in S310 of FIG. 5, the actuator control unit 310 controls the actuators based on the control amounts. In the present embodiment, the EPS motor 5 is controlled so that the steering angle δ follows the target steering angle δt, and the powertrain unit 6 and the brake unit 7 are controlled so that the longitudinal acceleration ax follows the target longitudinal acceleration axt.

### <Setting Procedure of Entry Prohibition Are>

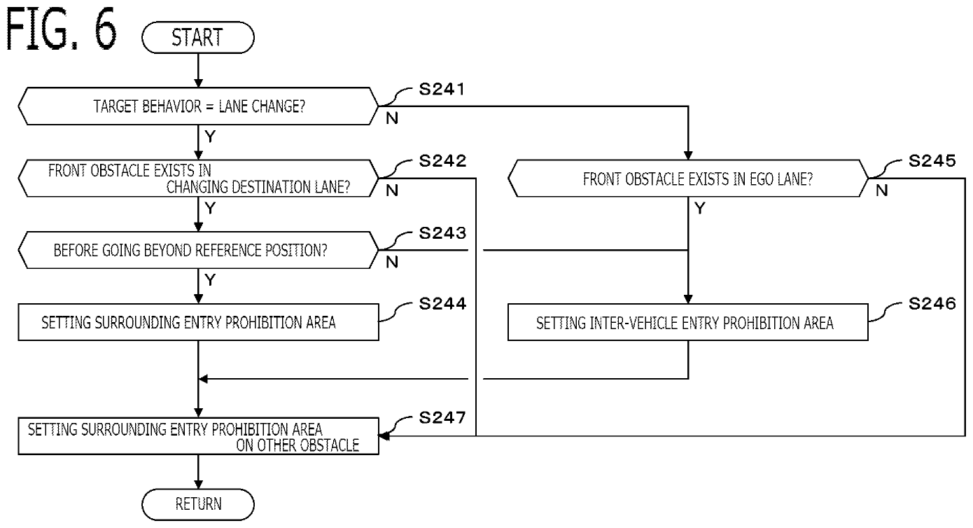

FIG. 6 is a flowchart showing setting procedure of the entry prohibition area. This processing is performed in S240 of FIG. 5.

In the present embodiment, a case where the entry prohibition area is set on the front obstacle is explained as an example, but the same is applicable to the rear obstacle.

First, in S241 of FIG. 6, it is determined whether or not the target behavior is the lane change. When it is determined that the target behavior is the lane change, the processing of S242 is performed. When it is determined that the target behavior is not the lane change, the processing of S245 is performed.

When it is determined that the target behavior is the lane change in S241 of FIG. 6, in S242 of FIG. 6, it is determined whether or not the front obstacle which is an obstacle existing in front of the ego vehicle in the changing destination lane exists. When it is determined that the front obstacle exists in the changing destination lane, the processing of S243 is performed, and the front obstacle in the changing destination lane is selected as an object obstacle. When it is determined that the front obstacle does not exist in the changing destination lane, the processing of S247 is performed.

When it is determined that the front obstacle exists in the changing destination lane in S242 of FIG. 6, a determination based on the position in the lateral direction of the ego vehicle is performed in S243 of FIG. 6. In the present embodiment, it is determined whether or not the position in the lateral direction of the ego vehicle is before going beyond a reference position which is set within a lateral range of the changing origin lane and the changing destination lane, to the changing destination lane side. As the reference position, the lane marking indicating the boundary between the changing origin lane and the changing destination lane is used. When it is determined to be before going beyond the reference position, the processing of S244 is performed. When it is determined to be after going beyond the reference position, the processing of S246 is performed. In the present embodiment, the lane marking is set as the reference position, but the reference position may be set to any positions within the lateral range of the changing origin lane and the changing destination lane besides that. For example, the reference position may be set so that it can be determined that the entire ego vehicle enter the changing destination lane, or the reference position may be set so that it can be determined whether a distance to the lane center is less than or equal to a prescribed value.

When it is determined that the ego lane is not the changing destination lane in S243 of FIG. 6, in S244 of FIG. 6, the surrounding entry prohibition area Ssurr is set so that a space where the ego vehicle can travel in the changing origin lane is left on the changing origin lane side of the obstacle selected as the object obstacle in S242 of FIG. 6, and the inter-vehicle distance between the obstacle and the ego vehicle is secured greater than or equal to the set distance. The surrounding entry prohibition area Ssurr is set around the obstacle. A length in the longitudinal direction of the surrounding entry prohibition area Ssurr with respect to the obstacle is set according to the set distance, and a length in the lateral direction with respect to the obstacle is set according to the lane width.

In the present embodiment, the elliptical surrounding entry prohibition area Ssurr is set. The surrounding entry prohibition area Ssurr is expressed inside an elliptic equation ζellps (X, Y)=0. Herein, ζellps (X, Y) is expressed by the next equation.

$$[ Math . 12 ]$$

$${ζ}_{ellps} ( X , Y ) = 1 + {\{ ( \frac{( X - {X}_{o} ( k ) ) \cdot cos {θ}_{o} ( k ) + ( Y - {Y}_{o} ( k ) ) \cdot sin {θ}_{o} ( k )}{{d}_{a} ( k )} ) \}}^{2} + {\{ ( \frac{( X - {X}_{o} ( k ) ) \cdot sin {θ}_{o} ( k ) + ( Y - {Y}_{o} ( k ) ) \cdot cos {θ}_{o} ( k )}{{d}_{b} ( k )} ) \}}^{2} \qquad ( 301 )$$

da (k) and db (k) are lengths of the semi-major axis and the semi-minor axis of the ellipse which is set on the obstacle at the prediction point k, respectively. The magnitudes of da (k) and db (k) may be adjusted according to the speed of the ego vehicle, or the speed of the obstacle. For example, da (k) and db (k) may be increased as the speed difference between the ego vehicle and the obstacle increases. The elliptical center does not need to coincide with the center position Xo (k), Yo (k) of the obstacle. The entry prohibition area set on the obstacle does not need to be the ellipse. As long as the shape is such that the ego vehicle can travel the side of the obstacle and the ego vehicle does not approach the obstacle greater than or equal to the set distance, any shape of the entry prohibition area may be set. It may be set not in the inertial coordinate system but in the route coordinate system.

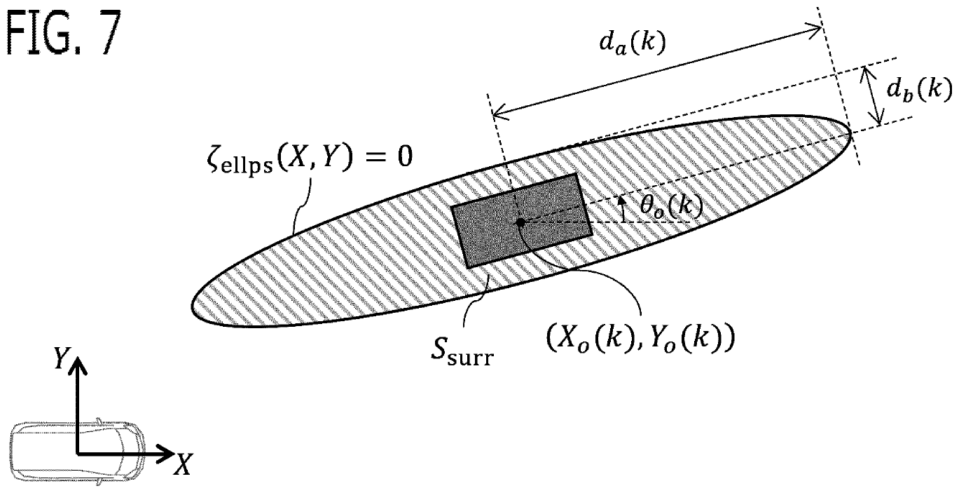

FIG. 7 is a schematic diagram showing the elliptical surrounding entry prohibition area Ssurr. The inside of the ellipse ζellps (X, Y)=0 centering on the center position Xo (k), Yo (k) of the obstacle is the surrounding entry prohibition areas Ssurr.

When it is determined that the target behavior is not the lane change in S241 of FIG. 6, in S245 of FIG. 6, it is determined whether or not the front obstacle exists in the ego lane. When it is determined that the front obstacle exists in the ego lane, the processing of S246 is performed, and the front obstacle in the ego lane is selected as the object obstacle. When it is determined that the front obstacle does not exist in the ego lane, the processing of S247 is performed. In the present embodiment, since only the lane keeping and the lane change are considered as the target behavior, S245 is the processing for the lane keeping.

When it is determined that the front obstacle exists in the ego lane in S245 of FIG. 6, or when it is determined to be after going beyond the reference position in S243 of FIG. 6, in S246 of FIG. 6, the inter-vehicle entry prohibition area SIVD is set on the obstacle selected as the object obstacle so that the inter-vehicle distance between the obstacle and the ego vehicle is secured greater than or equal to the set distance. In the present embodiment, a boundary line which crosses the changing origin lane and the changing destination lane in the lateral direction is set on the ego vehicle side by greater than or equal to the set distance from the obstacle; and the inter-vehicle entry prohibition area SIVD is set on the obstacle side of the boundary line. In this example, the boundary line is a straight shape.

For example, the inter-vehicle entry prohibition area SIVD is expressed by an area on the obstacle side bordering on the straight line equation ζstrght(s)=0 in the route coordinate system. Herein, for the front obstacle, ζstrght(s) is expressed by the next equation.

$$[ Math . 13 ]$$

$${ζ}_{strght} ( s ) = s - ( {s}_{o} ( k ) - {d}_{c} ( k ) ) \qquad ( 302 )$$

so (k) and dc (k) are a position in the tangential direction of the obstacle, and a distance between the centers of gravity to be secured at the prediction point k, respectively. For the rear obstacle, ζstrght(s) is expressed by the next equation.

$$[ Math . 14 ]$$

$${ζ}_{strght} ( s ) = s - ( {s}_{o} ( k ) - {d}_{c} ( k ) ) - s \qquad ( 303 )$$

The magnitude of dc (k) may be adjusted according to the speed of the ego vehicle, or the speed of the obstacle. For example, dc (k) may be increased as the speed difference between the ego vehicle and the obstacle increases. The entry prohibition area set on the obstacle does not need to be the straight shape. As long as the shape is such that the inter-vehicle distance between the obstacle and the ego vehicle can be secured greater than or equal to the set distance, any shape of the entry prohibition area may be set. It may be set not in the inertial coordinate system but in the route coordinate system.

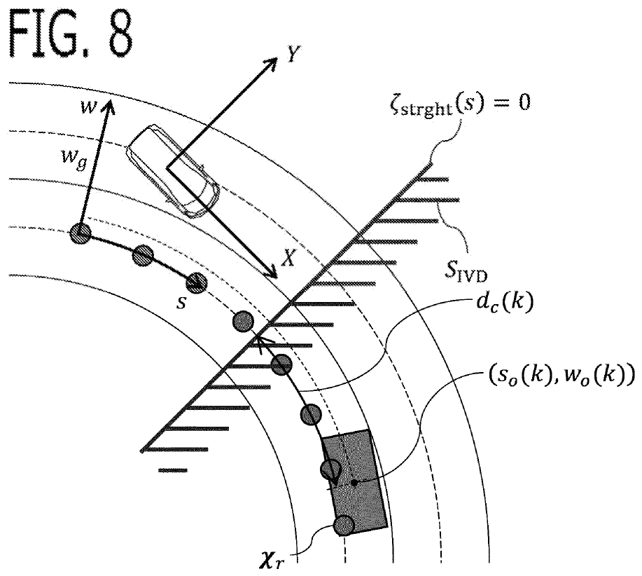

FIG. 8 is a schematic diagram showing the inter-vehicle entry prohibition area SIVD of straight shape. The point group expressed by χr is a reference route described below. In FIG. 8, the straight line ζstrght(s)=0 exists at a position away from the center position so (k), wo (k) of the obstacle by dc (k) in the tangential direction, in the route coordinate system; and an area on the obstacle side bordering on the ζstrght(s)=0 is the inter-vehicle entry prohibition area SIVD.

The magnitudes of da (k) and dc (k) may be set to coincide with the inter-vehicle distance dd to be secured finally. Accordingly, the consistent inter-vehicle distance can be secured before and after going beyond the reference position. But, depending on a positional relationship between the ego vehicle and the surrounding entry prohibition area when going beyond the reference position, if dc(k)=da(k)=dd is simply set, the ego vehicle may enter the inter-vehicle entry prohibition area at the present time (k=0). In the present embodiment, since the trajectory is calculated as the optimization problem, it is easier to solve the problem if the ego vehicle does not enter the inter-vehicle entry prohibition area at k=0 time point, that is, if the initial value does not violate the constraint. In order to prevent the ego vehicle from entering the inter-vehicle entry prohibition area at k=0 time point, the magnitude of dc (k) may be set according to the present inter-vehicle distance.

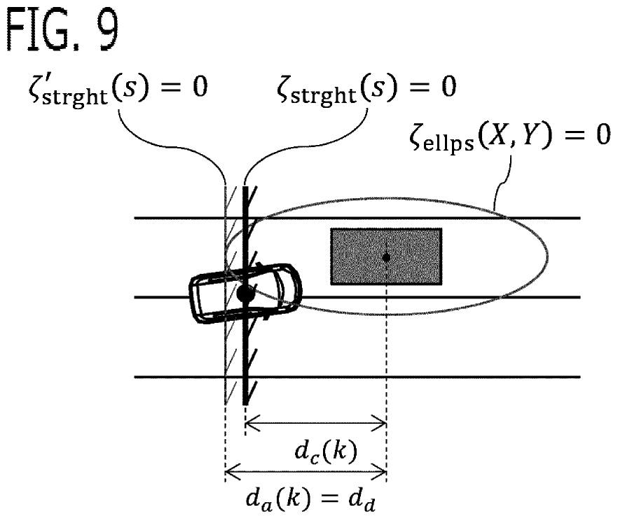

FIG. 9 is a schematic diagram showing the method to set the magnitude of dc (k) according to the present inter-vehicle distance. In FIG. 9, the ego vehicle is during the lane change, and is just after going beyond the lane marking. Since the ego vehicle locates more forward in the traveling direction than the rear end of ζellps (X, Y)=0, if dc (0)=da (0)=dd is set, a boundary such as ζ′strght(s)=0 is set, and the ego vehicle exists within the inter-vehicle entry prohibition area at the k=0 time point. Since it is desirable that the ego vehicle does not exist within the inter-vehicle entry prohibition area at k=0 time point, in the scene shown in FIG. 9, dc (k) is set based on the inter-vehicle distance at the time point of going beyond the lane marking. For example, if dc (0)=so (0)−s0 is set, the boundary is set such that the ego vehicle is not included in the inter-vehicle entry prohibition area, such as ζstrght(s)=0 in FIG. 9. Accordingly, the initial value no longer violates the constraint, and it is easier to solve the problem. But, in a case where the inter-vehicle distance dd to be secured finally is dd≠so (k)−s (k), if dc (k)=so (k)−s (k) is set at all prediction points k (k=0, . . . , N), the inter-vehicle distance cannot be converged to dd. Then, so that the inter-vehicle distance can be converged to dd finally, dc (k) may be set using a weighted average of dd and so (k)−s (k), such as dc (k)=w×dd+(1−w)×(so (k)−s (k)). Herein, a weight w is a function of k, and is a monotone increasing function such that w=0 at k=0, and w=1 at k=N. Accordingly, the initial value does not violate the constraint, and the inter-vehicle distance can be converged to the inter-vehicle distance dd to be secured.

Next, in S247 of FIG. 6, when the obstacle exists besides the object obstacle selected in S242 or S245 of FIG. 6, the surrounding entry prohibition area Ssurr is set on each obstacle. As long as the shape is such that the ego vehicle can travel the side of the obstacle and the ego vehicle does not approach the obstacle greater than or equal to the set distance, any shape of the surrounding entry prohibition area Ssurr set on each obstacle may be set. When the processing explained in S242 to S246 is performed for the rear obstacle, the surrounding entry prohibition area or the inter-vehicle entry prohibition area is set on the rear obstacle according to the conditional branch.

As described above, the entry prohibition area is changed based on the position in the lateral direction of the ego vehicle during the lane change. Accordingly, when the ego vehicle moves to the changing destination lane to a certain degree, the ego vehicle avoids the obstacle in the changing destination lane without returning to the changing origin lane. So, even when the obstacle in the changing destination lane accelerates or decelerates, the ego vehicle does not return to the changing origin lane unnaturally, and safety and comfort of the occupant are improved.

### <Generation Procedure of Target Trajectory>

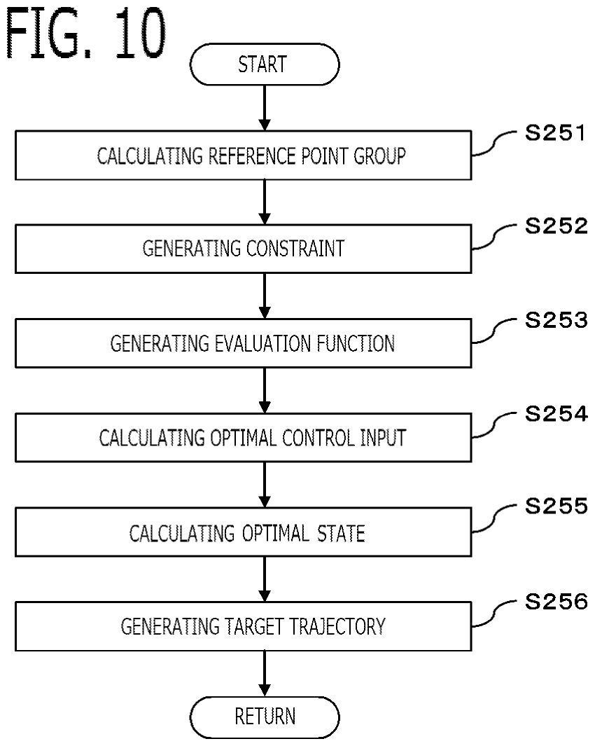

FIG. 10 is a flowchart showing the generation procedure of the target trajectory. This processing is performed in S250 of FIG. 5.

First, a reference point group is calculated in S251 of FIG. 10. Herein, the reference point group is series data of a reference position Xr, Yr, a reference route yaw angle ψr, and a reference vehicle speed Vr from the present time 0 to the prediction period Th future at the time interval Ts. Hereafter, the series data of the reference position Xr (k), Yr (k) (k=0, . . . , N) is referred to as the reference route χr.

The reference position Xr (k), Yr (k), the reference route yaw angle ψr (k), and the reference vehicle speed Vr (k) at each time (k=0, . . . , N) are determined as follows. First, the reference vehicle speed Vr (k) is determined based on the limit speed Vl of the traveling lane, and the vehicle speed Vp of the preceding vehicle, for example, is set to Vr (k)=Vl. Vr (k) does not need to be a constant value in the horizon.

Next, when the target behavior is the lane keeping, the reference position Xr (k), Yr (k), and the reference route yaw angle ψr (k) are determined based on X position and Y position, and the route yaw angle of the lane center so that the ego vehicle can travel along the target lane center. At the same time, conditions are set on the relation between the reference position Xr (k), Yr (k) and the reference vehicle speed Vr (k) so that the reference position Xr (k), Yr (k) and the reference vehicle speed Vr (k) are consistent with each other. That is, the reference position Xr (k), Yr (k) is determined so that following two equations are satisfied.

$$[ Math . 15 ]$$

$${Y}_{r} ( k ) = {l}_{e} ( {X}_{r} ( k ) ) ( k = 0 , … , N ) \qquad ( 401 )$$

$$\sqrt{{( {X}_{r} ( k ) - {X}_{r} ( k - 1 ) )}^{2} + {( {Y}_{r} ( k ) - {Y}_{r} ( k - 1 ) )}^{2}} = {V}_{r} ( k - 1 ) \cdot {T}_{s} ( k = 1 , … , N ) \qquad ( 402 )$$

The equation (401) is the condition for the reference position Xr (k), Yr (k) to exist on the function Y=le (X) (equation (205)) expressing the center of the ego lane. The equations (402) is the condition for the interval between the adjacent reference positions Xr (k−1), Yr (k−1) and Xr (k), Yr (k) to be equal to a moving amount of the ego vehicle in the time interval Ts. The reference route yaw angle ψr (k) can be determined by calculating a yaw angle of the ego lane center Y=le (X) at the reference position Xr (k), Yr (k) determined by these. Hereafter, the reference route for the lane keeping is referred to as a reference lane keeping route χrLK.

When the target behavior is the lane change, for example, a function Y=lLC (X) which expresses the reference route (a reference lane change route χrLC) for the lane change is generated by connecting from the present lane center to the target lane center so as to be continuous and smooth. Well-known methods, such as a spline curve and the fifth order function, are used for connection. Then, the reference position Xr (k), Yr (k) is determined using the next equation instead of the equation (401).

$$[ Math . 16 ]$$

$${Y}_{r} ( k ) = {l}_{LC} ( {X}_{r} ( k ) ) ( k = 0 , … , N ) \qquad ( 403 )$$

The reference route yaw angle ψr (k) can also be determined by calculating the yaw angle of the reference lane change route Y=1LC (X) at the reference position Xr (k), Yr (k) determined by these. The connection is made so that the reference lane change route χrLC can be generated such that the lane change is completed at a target required time tLC of the lane change. For example, the connection is made so that the movement to the target lane in the lateral direction is completed at a distance d where the ego vehicle moves to the longitudinal direction during the target required times tLC. The distance d may be calculated by time-integrating the reference vehicle speed Vr, or may be calculated by a product of the present vehicle speed VO and the target required time tLC. When the traveling lane is a curve, it may be connected in the route coordinate system. If the target required time of the lane change does not need to be specified, and the prediction period Th is sufficiently long, the reference position Xr (k), Yr (k) may be determined simply using the next equation instead of the equation (401), without generating the reference lane change route χrLC.

$$[ Math . 17 ]$$

$${Y}_{r} ( k ) = {l}_{t} ( {X}_{r} ( k ) ) ( k = 0 , … , N ) \qquad ( 404 )$$

Herein, Y=lt (X) is a function expressing the target lane center, and lt=le, ll, lr when the target lane is the ego lane, the left lane, and the right lane from the equation (205), the equation (206), and the equation (207), respectively.

The reference position Xr (k), Yr (k), the reference route yaw angle ψr (k), and the reference vehicle speed Vr (k) (k=0, . . . , N) calculated as described above are defined as the reference point group.

Next, in S252 of FIG. 10, the constraint g (x, u)<=0 is set. In the present embodiment, the function g is set as follows so that the centroid position Xg (k), Yg (k) of the ego vehicle at each prediction point k (k=0, . . . , N) does not enter the surrounding entry prohibition area Ssurr and the inter-vehicle entry prohibition area SIVD set in S240, and the control input u (k) is kept within a specified range.

$$[ Math . 18 ]$$

$$g ( k ) = [ \begin{matrix}{ζ}_{ellps} ( {X}_{g} ( k ) , {Y}_{g} ( k ) \\ {ζ}_{strght} ( {X}_{g} ( k ) , {Y}_{g} ( k ) \\ {j}_{xt} ( k ) - {jH}_{xt} \\ - {j}_{xt} ( k ) + {jL}_{xt} \\ {ω}_{t} ( k ) - ω {H}_{t} \\ - {ω}_{t} ( k ) + ω {L}_{t}\end{matrix} ] ( k = 0 , … , N - 1 ) \qquad ( 405 )$$

$$g ( N ) = [ \begin{matrix}{ζ}_{ellps} ( {X}_{g} ( N ) , {Y}_{g} ( N ) \\ {ζ}_{strght} ( {X}_{g} ( N ) , {Y}_{g} ( N )\end{matrix} ] \qquad ( 406 )$$

Herein, jHxt, jLxt, ωHt, and ωLt are an upper limit value and a lower limit value of each control input. The upper limit value and the lower limit value of each control input may be changed at each prediction point k. When the obstacle on which the surrounding entry prohibition area Ssurr and the inter-vehicle entry prohibition area SIVD are set does not exist, the elements corresponding to it are deleted from the equation (405) and the equation (406). In the present embodiment, the constraint is set only on the control input u, but the constraint may be set on the yaw rate, the lateral acceleration, and the like to improve riding comfort. The constraint may be changed according to the target behavior.

Next, in S253 of FIG. 10, the evaluation function J (the equation (103)) is set. In the present embodiment, vector valued functions h, hN regarding evaluation items are set as follows so that the target trajectory ξ for the ego vehicle to follow the reference point group (the reference position Xr (k), Yr (k), the reference route yaw angle ψr (k), the reference vehicle speed Vr (k) (k=0, . . . , N)) calculated in S251 can be generated, and the control input at that time becomes small.

$$[ Math . 19 ]$$

$$h = {[ {e}_{w} ( k ) , V ( k ) , {j}_{t} ( k ) , {ω}_{𝔱} ( k ) ]}^{T} \qquad ( 407 )$$

$${h}_{N} = {[ {e}_{w} ( N ) , V ( N ) ]}^{T} \qquad ( 408 )$$

ew (k) is a lateral deviation with respect to the reference position Xr (k), Yr (k) at the prediction point k (k=0, . . . , N), and is the next equation using the reference position Xr (k), Yr (k) and the reference route yaw angle År (k) at the prediction point k (k=0, . . . , N).

$$[ Math . 20 ]$$

$${e}_{w} ( k ) = cos {ψ}_{r} ( k ) \cdot ( {Y}_{g} ( k ) - {Y}_{r} ( k ) ) - sin {ψ}_{r} ( k ) \cdot ( {X}_{g} ( k ) - {X}_{r} ( k ) ) \qquad ( 409 )$$

The reference values r (k), r (N) are set as follows.

$$[ Math . 21 ]$$

$$r ( k ) = {[ 0 , {V}_{r} ( k ) , 0 , 0 ]}^{T} ( k = 0 , … , N - 1 ) \qquad ( 410 )$$

$$r ( N ) = {[ 0 , {V}_{r} ( N ) ]}^{T} \qquad ( 411 )$$

Herein, Vr (k) is the reference vehicle speed. Accordingly, the target trajectory generation unit 250 can generate the target trajectory such that the ego vehicle follows the reference point group with small control input. In order to improve the following property to the reference point group and the riding comfort, the route yaw angle, the yaw rate, the longitudinal acceleration, the lateral acceleration, and the like may be added to the evaluation items. The evaluation function may be changed according to the target behavior.

Next, in S254 of FIG. 10, the optimal control input u* is calculated by solving the constrained optimization problem (the equation (101)) using the evaluation function (the equation (103)) and the constraint (the equation (102)). The calculation of the optimal control input u* is performed using well-known methods, such as ACADO (Automatic Control And Dynamic Optimization) developed by the K.U. Leuven university, and AutoGen which is an automatic code generation tool for solving the optimization problem on the basis of the C/GMRES method. When ACADO or AutoGen is used, time series of the optimized control inputs (optimal control input) u* at each prediction point k (k=0, . . . , N−1) are outputted. That is, the output of S254 is the next equation.

$$[ Math . 22 ]$$

$${u}^{*} = [ {u}^{*} ( 0 ) … {u}^{*} ( N - 1 ) ] \qquad ( 412 )$$

$$= [ \begin{matrix}{j}_{xt}^{*} ( 0 ) & … & {j}_{xt}^{*} ( N - 1 ) \\ {ω}_{t}^{*} ( 0 ) & … & {ω}_{t}^{*} ( N - 1 )\end{matrix} ]$$

Herein, jxt*(k) and ωt*(k) (k=0, . . . , N−1) are the optimal values of the target longitudinal jerk and the target steering angle speed. A value such that the evaluation function is less than a prescribed threshold value may be set as the solution. When the evaluation function does not go below a threshold value within a prescribed number of iterations, a value which minimizes the evaluation function within the number of iterations may be set as the solution.

Next, in S255 of FIG. 10, the optimal state x* is calculated. In the calculation of optimal state x*, time series of the optimized vehicle states (optimal state) x* at each prediction point k (k=0, . . . , N) are calculated using the optimal control input u* and the vehicle model f. Therefore, the output of S255 is the next equation.

$$[ Math . 23 ]$$

$${x}^{*} = [ \begin{matrix}{x}^{*} ( 0 ) & … & {x}^{*} ( N )\end{matrix} ] = [ \begin{matrix}{X}_{g}^{*} ( 0 ) & … & {X}_{g}^{*} ( N ) \\ {Y}_{g}^{*} ( 0 ) & … & {Y}_{g}^{*} ( N ) \\ {θ}^{*} ( 0 ) & … & {θ}^{*} ( N ) \\ {β}^{*} ( 0 ) & … & {β}^{*} ( N ) \\ {γ}^{*} ( 0 ) & … & {γ}^{*} ( N ) \\ {V}^{*} ( 0 ) & … & {V}^{*} ( N ) \\ {a}_{x}^{*} ( 0 ) & … & {a}_{x}^{*} ( N ) \\ {a}_{x t}^{*} ( 0 ) & … & {a}_{x t}^{*} ( N ) \\ {δ}^{*} ( 0 ) & … & {δ}^{*} ( N ) \\ {δ}_{t}^{*} ( 0 ) & … & {δ}_{t}^{*} ( N )\end{matrix} ] \qquad ( 413 )$$

Herein, Xg*(k), Yg*(k), θ*(k), β*(k), γ*(k), V*(k), ax* (k), axt*(k), δ*(k), δt*(k) (k=0, . . . , N) are optimal values of the centroid position, the body yaw angle, the lateral slip angle, the yaw rate, the vehicle speed, the longitudinal acceleration, the target longitudinal acceleration, the steering angle, and the target steering angle, respectively.

Next, in S256 of FIG. 10, the target trajectory ξ is generated. The target trajectory ξ is generated based on the optimal state x* and the optimal control input u*. In the present embodiment, the optimal state x* is set as the target trajectory ξ. Therefore, the output of S256 is the next equation.

$$[ Math . 24 ]$$

$$ξ = [ \begin{matrix}{x}^{*} ( 0 ) & … & {x}^{*} ( N )\end{matrix} ] \qquad ( 414 )$$

The target trajectory ξ when the target behavior is the lane keeping is referred to as a target lane keeping trajectory ELK. The target trajectory ξ when the target behavior is the lane change is referred to as a target lane change trajectory ξLC. As explained in S251, if the target behavior is different, at least the reference route χr is different. But, besides that, the item and value of the constraint may be changed in S252, or the item and value of the evaluation function may be changed in S253.

<Comparison of Target Lane Change Trajectories when Front Obstacle Decelerates During Lane Change>

The difference in the behavior of the ego vehicle between a comparative example and the present embodiment when the front obstacle decelerates during the lane change will be explained.

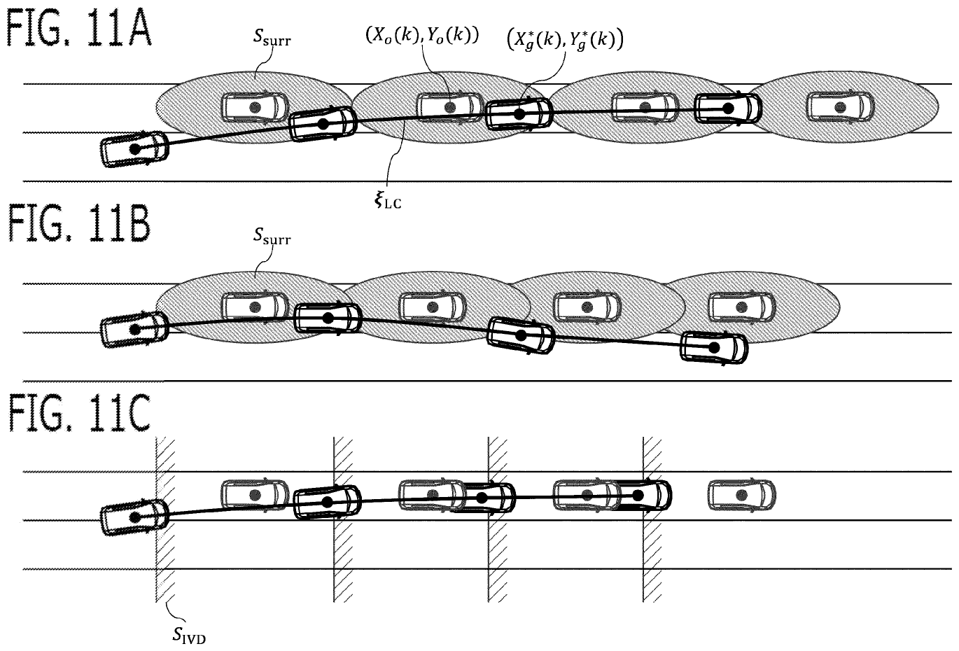

FIG. 11A to FIG. 11C are schematic diagrams showing the difference in the behavior of the ego vehicle in the comparative example and the present embodiment when the front obstacle decelerates during the lane change. The ego vehicle is changing lanes to the left lane, and the front obstacle exists in the left lane. FIG. 11A to FIG. 11C show the center position Xo (k), Yo (k) of the obstacle, and the optimal centroid position Xg*(k), Yg*(k) of the ego vehicle included in the target lane change trajectory ξLC, at each prediction point k (k=0, . . . , N) at a certain time.

FIG. 11A is a figure just before the ego vehicle goes beyond the lane marking, and is common to both the comparative example and the present embodiment. Since FIG. 11A is before going beyond the lane marking, the surrounding entry prohibition area Ssurr is set on the front obstacle. In FIG. 11A, it is predicted that the movement to the center of the changing destination lane is completed at the prediction final point.

Herein, a case where the front obstacle starts to decelerate immediately after FIG. 11A is considered. FIG. 11B is a figure after time elapsed from FIG. 11A and just after the ego vehicle goes beyond the lane marking in the comparative example. Since the front obstacle decelerated, it is necessary to avoid the front obstacle. In the comparative example, since the ego vehicle is not prohibited from returning to the changing origin lane, the trajectory is generated to avoid the collision with the front obstacle by returning to the changing origin lane and going around the side of the front obstacle as shown in FIG. 11B, depending on the weight of the evaluation function. However, except a case where excessive deceleration (for example, 3.0 m/ss or more) is necessary, it is unnatural for the ego vehicle to return to the changing origin lane after moving to the changing destination lane, and safety and comfort are reduced. The lane change which is the target behavior cannot be achieved, either.

FIG. 11C is a figure after time elapsed from FIG. 11A and just after the ego vehicle goes beyond the lane marking in the present embodiment. Since the ego vehicle goes beyond the lane marking, the inter-vehicle entry prohibition area SIVD is set. Since the front obstacle decelerated, it is necessary to avoid the front obstacle. However, by setting the inter-vehicle entry prohibition area SIVD, it is no longer possible to avoid the collision with the front obstacle by returning to the changing origin lane and going around the side of the front obstacle. Since the collision with the front obstacle can be avoided only by deceleration, the trajectory is generated to avoid the collision with the front obstacle while decelerating, without returning to the changing origin lane as shown in FIG. 11C. This is a natural behavior compared with FIG. 11B, and safety and comfort are improved. Then, similar to FIG. 11A, since it is predicted that the movement to the center of the changing destination lane is completed at the prediction final point, the lane change which is the target behavior can also be achieved.

### Summary of Embodiment 1

According to this configuration, the entry prohibition area is changed based on the position in the lateral direction of the ego vehicle during the lane change. Accordingly, when the ego vehicle moves to the changing destination lane to a certain degree, the ego vehicle avoids the obstacle in the changing destination lane without returning to the changing origin lane. So, even when the obstacle in the changing destination lane accelerates or decelerates, the ego vehicle does not return to the changing origin lane unnaturally, and safety and comfort of the occupant are improved.

### Embodiment 2

In Embodiment 1, after the ego vehicle moves to the changing destination lane, the inter-vehicle entry prohibition area is set so that the ego vehicle avoids the collision with the obstacle without returning to the changing origin lane. Instead of this, the entry prohibition area (hereafter, referred to as a lane entry prohibition area) may be set so that the ego vehicle does not deviate from the changing destination lane, and the surrounding entry prohibition area may be set. Accordingly, similar to Embodiment 1, when the ego vehicle moves to the changing destination lane to a certain degree, the ego vehicle avoids the obstacle in the changing destination lane without returning to the changing origin lane. So, even when the obstacle in the changing destination lane accelerates or decelerates, the ego vehicle does not return to the changing origin lane unnaturally, and safety and comfort of the occupants are improved.

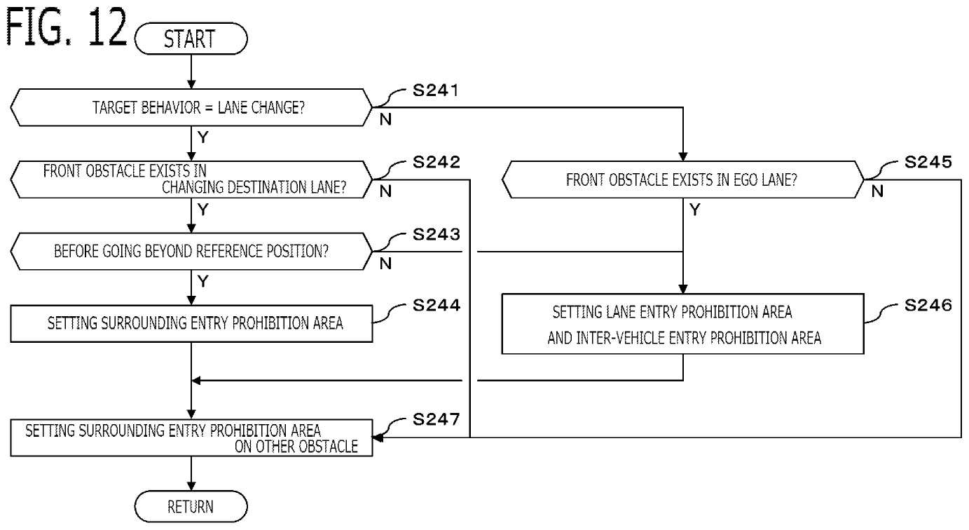

Embodiment 2 will be explained in the following. The explanations overlapping with Embodiment 1 are omitted herein. A difference between Embodiment 2 and Embodiment 1 is only S246 of FIG. 12.

### <Setting Procedure of Entry Prohibition Are>

S246 of FIG. 12 in Embodiment 2 will be explained. Similar to Embodiment 1, when it is determined that the front obstacle exists in the ego lane in S245 of FIG. 12, or when it is determined to be after going beyond the prescribed reference position in S243 of FIG. 12, in S246 of FIG. 12, the lane entry prohibition area Slane and the surrounding entry prohibition area Ssurr are superimposed and set on the obstacle selected as the object obstacle so that the ego vehicle does not deviate from the changing destination lane, and the inter-vehicle distance between the obstacle and the ego vehicle is secured greater than or equal to the set distance. In the present embodiment, the lane entry prohibition area Slane is an area outside the lane marking of the changing destination lane. But, when a position other than the lane marking is selected as the reference position in S243 of FIG. 12, the boundary of the lane entry prohibition area Slane is adjusted in the lateral direction to be consistent with the selected reference position. In the present embodiment, the super elliptical surrounding entry prohibition area Ssurr is set. At this time, the surrounding entry prohibition area Ssurr is expressed inside the super elliptic equation ζsup (X, Y)=0. Herein, ζsup (X, Y) is expressed by the next equation.

$$[ Math . 25 ]$$

$${ζ}_{sup} ( X , Y ) = 1 - {\{ ( \frac{( X - {X}_{o} ( k ) ) \cdot cos {θ}_{o} ( k ) + ( Y - {Y}_{o} ( k ) ) \cdot sin {θ}_{o} ( k )}{{d}_{a} ( k )} ) \}}^{n} + {\{ ( \frac{( X - {X}_{o} ( k ) ) \cdot sin {θ}_{o} ( k ) + ( Y - {Y}_{o} ( k ) ) \cdot cos {θ}_{o} ( k )}{{d}_{b} ( k )} ) \}}^{n} \qquad ( 501 )$$

da (k) and db (k) are lengths of the semi-major axis and the semi-minor axis of the super ellipse set on the obstacle at the prediction point k, respectively. n is an order of the ellipse, and may be even number greater than or equal to 4. In the present embodiment, n=8. The magnitudes of da (k) and db (k) may be adjusted according to the speed of the ego vehicle, or the speed of the obstacle. For example, da (k) and db (k) may be increased as the speed difference between the ego vehicle and the obstacle increases. The super elliptical center does not need to coincide with the center position Xo (k), Yo (k) of the obstacle. The entry prohibition area set on the obstacle does not need to be the super ellipse. As long as the shape is such that the ego vehicle can travel the side of the obstacle and the ego vehicle does not approach the obstacle greater than or equal to the set distance in the longitudinal direction, any shape of the entry prohibition area may be set. It may be set not in the inertial coordinate system but in the route coordinate system.

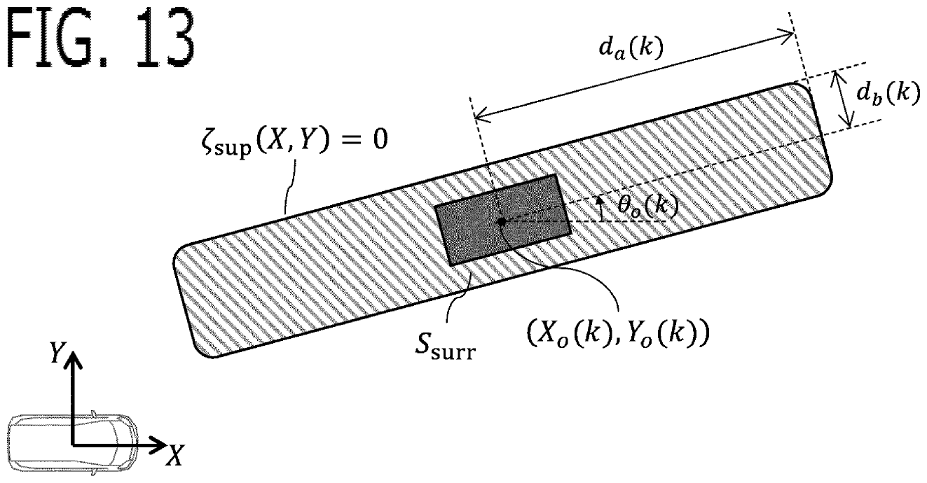

FIG. 13 is a schematic diagram showing the super elliptical surrounding entry prohibition area Ssurr. The inside of the super ellipse ζsup (X, Y)=0 centering on the center position Xo (k), Yo (k) of the obstacle is the surrounding entry prohibition areas Ssurr.

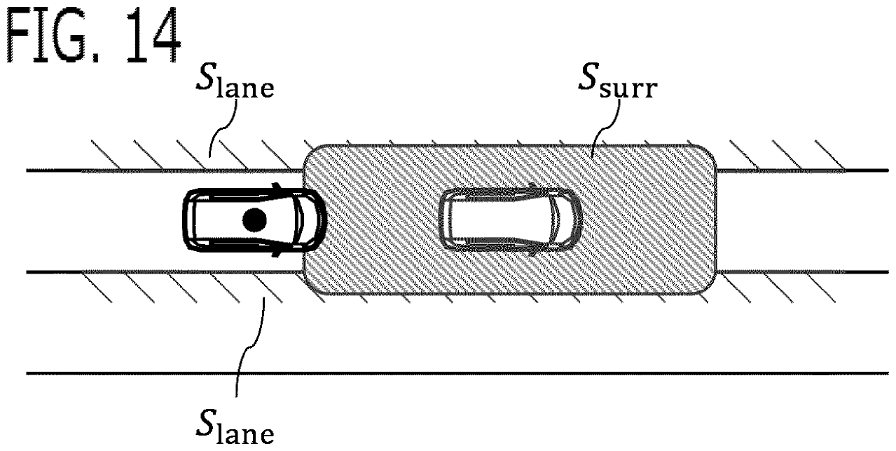

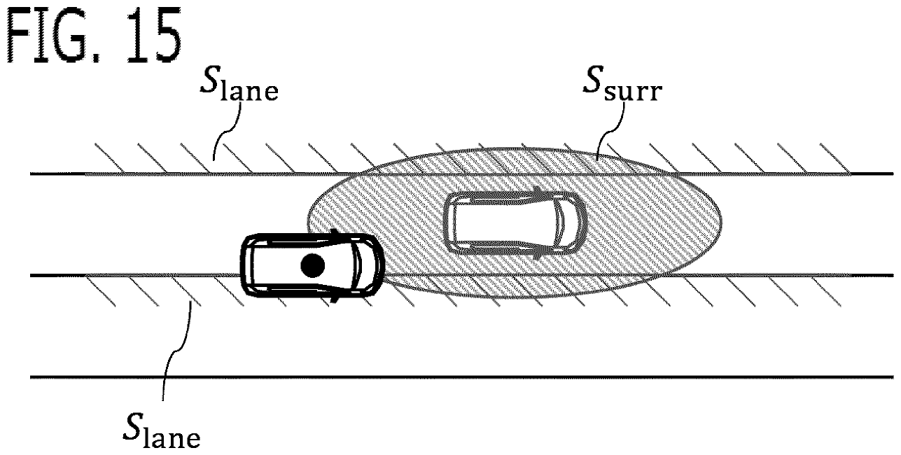

FIG. 14 is a schematic diagram showing the result of superimposing the lane entry prohibition area Slane and the super elliptical surrounding entry prohibition area Ssurr. The superimposed result is a U-shaped entry prohibition area. Accordingly, even if the front obstacle decelerates after the ego vehicle moves to the changing destination lane, the ego vehicle avoids the collision with the front obstacle while decelerating, without returning to the changing origin lane. The reason why the surrounding entry prohibition area Ssurr is the super elliptic shape is to make the boundary of the area almost flat shape with respect to the traveling direction. If the surrounding entry prohibition area Ssurr is a convex shape such as the elliptic shape, the ego vehicle may not be able to escape from a recessed part and reach the center of the changing destination lane, as shown in FIG. 15. If the surrounding entry prohibition area Ssurr is the super elliptic shape, such possibility is eliminated and the ego vehicle can reach the center of the changing destination lane.

### Summary of Embodiment 2

According to this configuration, after the ego vehicle moves to the changing destination lane to a certain degree, by setting the lane entry prohibition area and the surrounding entry prohibition area, the ego vehicle avoids the obstacle in the changing destination lane without returning to the changing origin lane. So, even when the obstacle in the changing destination lane accelerates or decelerates, the ego vehicle does not return to the changing origin lane unnaturally, and safety and comfort of the occupants are improved.

### Embodiment 3

In Embodiment 1, after the ego vehicle goes beyond the reference position during the lane change, the entry prohibition area is set such that the ego vehicle avoids the collision with the obstacle in the changing destination lane without returning to the changing origin lane. However, exceptionally, it may be better for the ego vehicle to return to the changing origin lane and avoid the collision with the obstacle in the changing destination lane. In such a case, even after the ego vehicle goes beyond the reference position, the entry prohibition area may be set such that the ego vehicle returns to the changing origin lane and avoids the collision with the obstacle in the changing destination lane. The case where it is better for the ego vehicle to return to the changing origin lane and avoid the collision with the obstacle in the changing destination lane is a case where the absolute value of acceleration or deceleration required to avoid the collision with the obstacle is greater than or equal to a determination value, for example. Accordingly, in such an exceptional case, the ego vehicle can return to the changing origin lane and avoid the collision, so safety and comfort are improved.

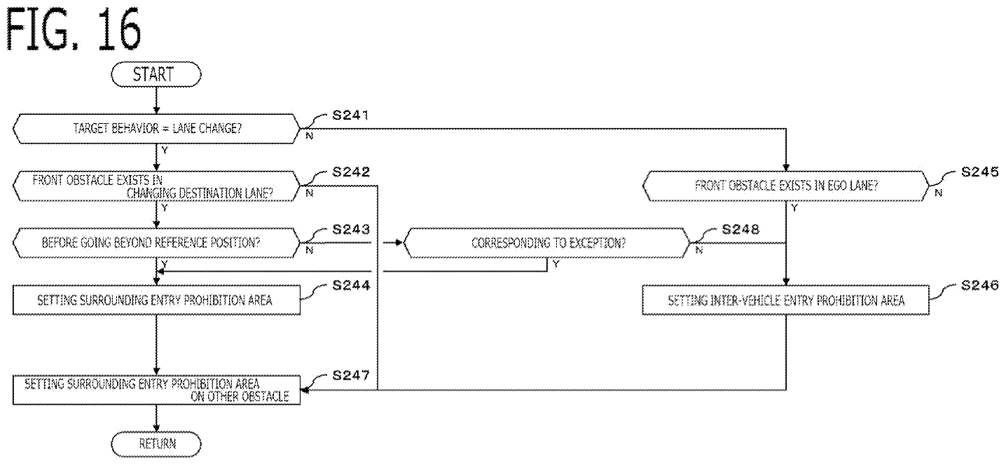

Embodiment 3 will be explained in the following. The explanations overlapping with Embodiment 1 are omitted herein. A difference between Embodiment 3 and Embodiment 1 is only S248 of FIG. 16.

### <Setting Procedure of Entry Prohibition Are>

S248 of FIG. 16 in Embodiment 3 will be explained. When it is determined to be after going beyond the prescribed reference position in S243 of FIG. 16, in S248 of FIG. 16, it is determined whether it corresponds to the exception. When it is determined that it corresponds to the exception, processing of S244 of FIG. 16 is performed. When it is determined that it does not correspond to the exception, processing of S246 of FIG. 16 is performed. The exception here is the case where it is better for the ego vehicle to return to the changing origin lane and avoid the collision with the obstacle in the changing destination lane. For example, the exception is a case where the front obstacle in the changing destination lane suddenly decelerates, and the absolute value of deceleration of the ego vehicle required to maintain the inter-vehicle distance is greater than or equal to a determination value (for example, 3.0 m/ss), or a case where the rear obstacle in the changing destination lane suddenly accelerates, and the absolute value of acceleration of the ego vehicle required to maintain the inter-vehicle distance is greater than or equal to a determination value (for example, 3.0 m/ss). In such a case, if the ego vehicle tries to avoid the collision without returning to the changing origin lane, sudden deceleration and sudden acceleration are necessary and it is dangerous, so it is better to return to the changing origin lane and avoid the collision. By processing of S248 FIG. 16, the surrounding entry prohibition area is set in S244 of FIG. 16 in case of the exception, so it is possible to avoid a collision by returning to the changing origin lane.

The exception is not limited to the above. But, the exception may be any case where it is better to return to the changing origin lane and avoid the collision, such as a case where a space greater than or equal to a determination value cannot be secured in the changing destination lane. The case where the space greater than or equal to the determination value cannot be secured is a case where other obstacle exist within a prescribed determination range (for example, a distance that the ego vehicle travels in 0.8 s) from the ego vehicle in the longitudinal direction of the changing destination lane; or a case where the inter-vehicle distance between the front obstacle and the rear obstacle in the changing destination lane becomes narrow; or a case where other obstacle enters into the changing destination lane from the further behind lane of the changing destination lane.

### Summary of Embodiment 3

According to this configuration, in the case where, exceptionally, it is better for the ego vehicle to return to the changing origin lane and avoid the collision with the obstacle in the changing destination lane, the ego vehicle can return to the changing origin lane and avoid the collision, so safety and comfort are improved.

### <Summary of Aspects of the Present Disclosure>

Hereinafter, the aspects of the present disclosure is summarized as appendixes.

### (Appendix 1)

A vehicle control apparatus comprising:
an entry prohibition area setting unit that sets an entry prohibition area of an ego vehicle, based on at least one of a movement prediction of an obstacle, and/or road information;
a target trajectory generation unit that calculates a target trajectory in future of the ego vehicle under a constraint of not entering into the entry prohibition area; and
a vehicle control unit that controls a traveling of the ego vehicle based on the target trajectory,
wherein, when the target trajectory generation unit calculates the target trajectory for changing lanes from a changing origin lane to a changing destination lane, the entry prohibition area setting unit changes the entry prohibition area, based on a position in a lateral direction of the ego vehicle with respect to the changing origin lane or the changing destination lane.

### (Appendix 2)

The vehicle control apparatus according to Appendix 1,
wherein, after the position in the lateral direction goes beyond a reference position which is set within a lateral range of the changing origin lane and the changing destination lane, to the changing destination lane side, the entry prohibition area setting unit sets the entry prohibition area such that the ego vehicle avoids a collision with the obstacle which exists in the changing destination lane without returning to the changing origin lane.

### (Appendix 3)

The vehicle control apparatus according to Appendix 2,
wherein, after the position in the lateral direction goes beyond the reference position, the entry prohibition area setting unit sets the entry prohibition area such that an inter-vehicle distance between the obstacle and the ego vehicle is secured greater than or equal to a set distance so that the ego vehicle avoids the collision with the obstacle which exists in the changing destination lane without returning to the changing origin lane.

### (Appendix 4)

The vehicle control apparatus according to Appendix 2,
wherein, after the position in the lateral direction goes beyond the reference position, the entry prohibition area setting unit sets the entry prohibition area such that the ego vehicle does not deviate from the changing destination lane and the entry prohibition area such that an inter-vehicle distance between the obstacle and the ego vehicle is secured greater than or equal to a set distance so that the ego vehicle avoids the collision with a front obstacle which is the obstacle existing in front of the ego vehicle in the changing destination lane without returning to the changing origin lane.

### (Appendix 5)

The vehicle control apparatus according to any one of Appendixes 2 to 4,
wherein the reference position is a lane marking which indicates a boundary between the changing origin lane and the changing destination lane.

### (Appendix 6)

The vehicle control apparatus according to any one of Appendixes 2 to 5,
wherein the entry prohibition area setting unit determines whether or not a present state corresponds to an exception regarding the ego vehicle; and when determining that it corresponds to the exception, the entry prohibition area setting unit sets the entry prohibition area such that the ego vehicle avoids the collision with the obstacle which exists in the changing destination lane by returning to the changing origin lane, even after the position in the lateral direction goes beyond the reference position.

### (Appendix 7)

The vehicle control apparatus according to Appendix 6,
wherein the exception is a case where an absolute value of acceleration or deceleration required for the ego vehicle to avoid the collision with the obstacle without returning to the changing origin lane is greater than or equal to a determination value.

### (Appendix 8)

The vehicle control apparatus according to Appendix 6 or 7,
wherein the exception is a case where a space greater than or equal to a determination value for the ego vehicle to change lanes cannot be secured in the changing destination lane.

### (Appendix 9)

The vehicle control apparatus according to Appendix 3,
wherein, after the position in the lateral direction goes beyond the reference position, the entry prohibition area setting unit sets a boundary line which crosses the changing origin lane and the changing destination lane in a lateral direction on the ego vehicle side by greater than or equal to the set distance from the obstacle which exists in the changing destination lane, and sets the entry prohibition area on the obstacle side of the boundary line.

### (Appendix 10)

The vehicle control apparatus according to Appendix 3 or 9,
wherein the entry prohibition area setting unit sets the set distance to a distance less than or equal to the inter-vehicle distance between the ego vehicle and the obstacle at a time point when the position in the lateral direction goes beyond the reference position.

### (Appendix 11)

The vehicle control apparatus according to any one of Appendixes 2 to 10,
wherein, before the position in the lateral direction goes beyond the reference position, the entry prohibition area setting unit sets the entry prohibition area such that a space where the ego vehicle can travel in the changing origin lane is left on the changing origin lane side of the obstacle and the inter-vehicle distance between the obstacle and the ego vehicle is secured greater than or equal to a set distance.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A vehicle control apparatus comprising at least one processor configured to implement:
an entry prohibition area setter that sets an entry prohibition area of an ego vehicle, based on at least one of a movement prediction of an obstacle, and/or road information;
a target trajectory generator that calculates a target trajectory in future of the ego vehicle under a constraint of not entering into the entry prohibition area; and
a vehicle controller that controls a traveling of the ego vehicle based on the target trajectory,
wherein, when the target trajectory generator calculates the target trajectory for changing lanes from a changing origin lane to a changing destination lane, the entry prohibition area setter changes the entry prohibition area, based on a position in a lateral direction of the ego vehicle with respect to the changing origin lane or the changing destination lane.

2. The vehicle control apparatus according to claim 1,
wherein, after the position in the lateral direction goes beyond a reference position which is set within a lateral range of the changing origin lane and the changing destination lane, to the changing destination lane side, the entry prohibition area setter sets the entry prohibition area such that the ego vehicle avoids a collision with the obstacle which exists in the changing destination lane without returning to the changing origin lane.

3. The vehicle control apparatus according to claim 2,
wherein, after the position in the lateral direction goes beyond the reference position, the entry prohibition area setter sets the entry prohibition area such that an inter-vehicle distance between the obstacle and the ego vehicle is secured greater than or equal to a set distance so that the ego vehicle avoids the collision with the obstacle which exists in the changing destination lane without returning to the changing origin lane.

4. The vehicle control apparatus according to claim 2,
wherein, after the position in the lateral direction goes beyond the reference position, the entry prohibition area setter sets the entry prohibition area such that the ego vehicle does not deviate from the changing destination lane and the entry prohibition area such that an inter-vehicle distance between the obstacle and the ego vehicle is secured greater than or equal to a set distance so that the ego vehicle avoids the collision with a front obstacle which is the obstacle existing in front of the ego vehicle in the changing destination lane without returning to the changing origin lane.

5. The vehicle control apparatus according to claim 2,
wherein the reference position is a lane marking which indicates a boundary between the changing origin lane and the changing destination lane.

6. The vehicle control apparatus according to claim 2,
wherein the entry prohibition area setter determines whether or not a present state corresponds to an exception regarding the ego vehicle; and when determining that it corresponds to the exception, the entry prohibition area setter sets the entry prohibition area such that the ego vehicle avoids the collision with the obstacle which exists in the changing destination lane by returning to the changing origin lane, even after the position in the lateral direction goes beyond the reference position.

7. The vehicle control apparatus according to claim 6,
wherein the exception is a case where an absolute value of acceleration or deceleration required for the ego vehicle to avoid the collision with the obstacle without returning to the changing origin lane is greater than or equal to a determination value.

8. The vehicle control apparatus according to claim 6,
wherein the exception is a case where a space greater than or equal to a determination value for the ego vehicle to change lanes cannot be secured in the changing destination lane.

9. The vehicle control apparatus according to claim 3,
wherein, after the position in the lateral direction goes beyond the reference position, the entry prohibition area setter sets a boundary line which crosses the changing origin lane and the changing destination lane in a lateral direction on the ego vehicle side by greater than or equal to the set distance from the obstacle which exists in the changing destination lane, and sets the entry prohibition area on the obstacle side of the boundary line.

10. The vehicle control apparatus according to claim 3,
wherein the entry prohibition area setter sets the set distance to a distance less than or equal to the inter-vehicle distance between the ego vehicle and the obstacle at a time point when the position in the lateral direction goes beyond the reference position.

11. The vehicle control apparatus according to claim 2,
wherein, before the position in the lateral direction goes beyond the reference position, the entry prohibition area setter sets the entry prohibition area such that a space where the ego vehicle can travel in the changing origin lane is left on the changing origin lane side of the obstacle and the inter-vehicle distance between the obstacle and the ego vehicle is secured greater than or equal to a set distance.
